(19) United States
(12) Patent Application Publication
(10) Pub. No.: US 2009/0166413 A1
(43) Pub. Date: Jul. 2, 2009

(54) ENTRANCE GUARD SYSTEM USING ARBITRARY CARD

(75) Inventor: Lei SONG, Beijing (CN)

Correspondence Address: YING CHEN;Chen Yoshimura LLP, 255 S. GRAND AVE., # 215, LOS ANGELES, CA, 90012, US

(73) Assignee: BEIJING RUTIAN SCIENCE AND TECHNOLOGY CO., LTD, Beijing (CN)

(21) Appl. No.: 12/120,539

(22) Filed: May 14, 2008

(30) Foreign Application Priority Data
Dec. 29, 2007 (CN) 200710304722.6

(51) Int. Cl. G06K 5/00

(52) U.S. Cl. 235/382

(57) ABSTRACT

This invention relates an entrance guard system using arbitrary card comprising one or more card readers for entrance guard controlling, one or more entrance guard controllers, a CPU and one or more guest information input devices, wherein each of the guest information input device includes a guest information reader, a entrance card writing device and a manual input device used for inputting an instruction of registering guest information to the CPU. The CPU acquires the card information captured by a said guest information reader and stores the card information and other guest information in a guest information database as the guest's identification information. This system can use an arbitrary electron card as entrance card.

### BACKGROUND OF THE INVENTION

1. Field of the Invention

This invention relates to an entrance guard system using arbitrary card, which can adopt an arbitrary card as identification card of the entrance guard system.

2. Description of the Related Art

The existing entrance guard system comprises a card reader for entrance guard controlling, entrance guard controllers and a CPU. The card reader is connected to the entrance guard controller to input the card information. The entrance guard controller is connected to the CPU to send card information and entrance statues information. The CPU will generate entrance guard records after receiving card information, then match the information with guest identification information in the database and send opening instruction to the entrance guard controller when the matching is successful. The entrance guard controller will send opening signal to the entrance switch to open the entrance after receiving opening instruction from the CPU. There is a guest information input device in the CPU and this input device includes an entrance card writing device and a manual input device. This manual input device will input guest card information of fixed format as well as storage and card writing instruction. The CPU will write the guest card information and card writing record in guest information database and generate guest identification information, which will be written on special entrance card via card writing device. The disadvantage of this technique is that the card information is generated manually and written on special entrance card, therefore the guests can access only when they carry this special card and no other card is available. For this reason, the guests need carry more electron cards, which cause more inconvenience.

### SUMMARY OF THE INVENTION

To overcome the disadvantage of present techniques, this invention offers an entrance guard system using arbitrary card and the guests can access using their existing card.

The technical solution of this invention: an entrance guard system using arbitrary card, comprising one or more card readers for entrance guard controlling, one or more entrance guard controllers, a CPU and one or more guest information input devices, wherein each of the guest information input device includes a guest information reader, a entrance card writing device and a manual input device used for inputting an instruction for registering guest information to the CPU, wherein the CPU sends an instruction of reading guest information to a said guest information reader according to the instruction for registering guest information inputted by a said manual input device, acquires the card information captured by a said guest information reader and stores the card information and other guest information inputted manually by a said manual input device in a guest information database, wherein each of the card readers for entrance guard controlling is connected with a relevant said entrance guard controller to input card information to the entrance guard controller, each of the entrance guard controllers is connected to the CPU to send card information and entrance statues information to the CPU, the CPU generates an entrance guard record after receiving a card information and then match the card information with relevant guest identification information in its database, if the matching is successful, sends an opening instruction to a relevant said entrance guard controller, the entrance guard controller generates an opening signal and sends the signal to an entrance switch to open the relevant entrance after receiving the opening instruction from the CPU.

The number of the entrance guard controllers may be more than one, the CPU and the entrance guard controllers linked in a local computer network.

The local computer network includes one or more network communication devices; a said network communication device is a communication platform, a hub or a connecting wire.

The network communication device is an Ethernet network or a wireless network.

Each of the entrance guard controllers is connected to a controlling device of electric lock and a display unit.

Because this invention provides a guest information reader connected with the CPU, this reader can read any universal electron card under the supporting software and regard the information on the card as guest identification information, the guests can employ any universal electron as entrance card, which settles the inconvenience of increasing entrance card, saves the cost of using entrance card and is favorable for the construction of a conservation-minded society.

### BRIEF DESCRIPTION OF THE DRAWING

FIG. 1 is a structural scheme of an embodiment of this invention.

### DETAILED DESCRIPTION OF THE PREFERRED EMBODIMENTS

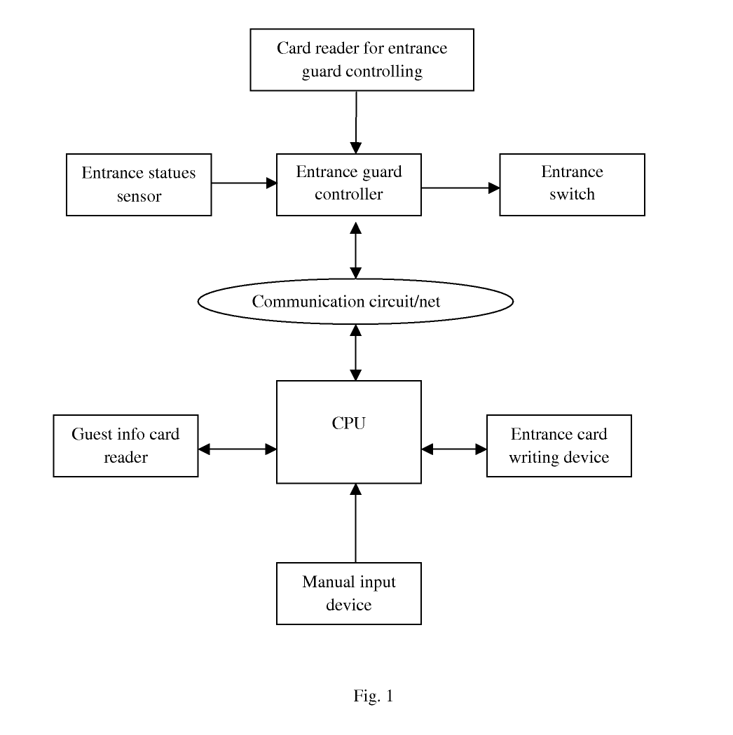

As shown in FIG. 1, this invention offers an entrance guard system using arbitrary card, comprising a card reader for entrance guard controlling, entrance guard controllers and a CPU. There is a guest information input device in the CPU and this input device includes a guest information reader, an entrance card writing device and a manual input device. This manual input device will input guest information registration instruction to the CPU while the CPU will send reading instruction to the guest information reader according to the guest information registration instruction; meanwhile acquires the card information captured by the guest information reader and inputs this card information in the guest information database as well as the guest information inputted manually. The card reader is connected to the entrance guard controller to input the card information. The entrance guard controller is connected to the CPU to send card information and entrance statues information. The CPU will generate entrance guard records after receiving card information, then match the information with guest identification information in the database and send opening instruction to the entrance guard controller when the matching is successful. The entrance guard controller will send opening signal to the entrance switch to open the entrance after receiving opening instruction from the CPU.

The key technique of the invention changes the situation of making special card for entrance guard system under present techniques but reads-in existing card of the guest to the CPU via guest information reader for guest information registering as guest identification information, so the guests can access using their existing cards. This technical plan gets plenty of embodiments and can be applied on present entrance guard systems via connecting several card readers on the CPU (applied to different electron cards respectively, e.g. magnetic card, IC card, non-contact IC chip with induced emission function). Supplements and improvements are needed for the original software to apply to the invention if employed in the present techniques.

The following is an embodiment on an entrance guard system adopting LAN (local computer network) communication technique.

An entrance system using card and adopting computer LAN carries out communications via the LAN composed of the centralized CPU and entrance guard controllers on each entrance terminal. The entrance guard controllers are only responsible for acquiring, encrypting guest identification information on entrance card and then send them to the CPU for further processing, which greatly reduces the software and hardware requirements and enlarges the service range due to the longer distance between the CPU and every entrance guard controller. This system is composed of hardware section and software section, wherein the hardware section comprises a CPU, several entrance guard controllers and network communication device connecting the CPU and entrance guard controllers. A LAN is formed by the CPU and several entrance guard controllers. For the processing of guest identification information on entrance card, the entrance guard controllers are only responsible for acquiring, encrypting guest identification information on entrance card and then send them to the CPU for further processing. The CPU will carry out decrypting and other processing to the received data, recover them into the guest identification information acquiring from the card, then compare the recovered information with corresponding ones in database and finally send the result of comparison back to the entrance controller via network communication device. The entrance controller will decide to open or lock the entrance according to the result

The CPU is responsible for the information management of the entire system. The entrance guard controller is connected to the terminal card reader of entrance guard, the lock control box, the electric lock and the display unit. The network communication device is composed of communication platform, a hub and connecting wires while the terminal card reader of entrance guard, the lock control box and the display unit can also be connected to the communication platform, which is connected with the CPU via the hub and connecting.

The LAN composed by the CPU and entrance guard controllers can be wired Ethernet or wireless network.

There is at least one entrance guard controller.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. An entrance guard system using arbitrary card, comprising:
one or more card readers for entrance guard controlling;
one or more entrance guard controllers;
a CPU; and
one or more guest information input devices,
wherein each of the guest information input devices includes a guest information reader, an entrance card writing device and a manual input device for inputting an instruction for registering guest information to the CPU,
wherein when registering a guest, the CPU sends an instruction of reading guest information to the guest information reader according to the instruction of registering guest information inputted by the manual input device, acquires card information captured by the guest information reader and stores the card information and other guest information inputted manually by the manual input device in a guest information database,
wherein each of the card readers for entrance guard controlling is connected with a corresponding one of the entrance guard controllers to input card information to the entrance guard controller when admitting a guest, wherein each of the entrance guard controllers is connected to the CPU to send the card information and entrance statues information to the CPU, wherein the CPU generates an entrance guard record after receiving the card information and then matches the card information with guest identification information in the guest information database, wherein if the matching is successful, the CPU sends an opening instruction to the corresponding entrance guard controller, wherein the entrance guard controller generates an opening signal and sends the signal to an entrance switch to open the corresponding entrance after receiving the opening instruction from the CPU.

2. The system of claim 1, wherein the system includes more than one entrance guard controllers, and wherein the CPU and the entrance guard controllers are linked via a local computer network.

3. The system of claim 2, wherein the local computer network includes one or more network communication devices.

4. The system of claim 3, wherein the network communication device is a communication platform, a hub or a connecting wire.

5. The system of claim 4, wherein the local computer network is an Ethernet network or a wireless network.

6. The system of claim 1, wherein each of the entrance guard controllers is connected to a controlling device of an electric lock and a display unit.

7. The system of claim 2, wherein each of the entrance guard controllers is connected to a controlling device of an electric lock and a display unit.

8. The system of claim 3, wherein each of the entrance guard controllers is connected to a controlling device of an electric lock and a display unit.

9. The system of claim 4, wherein each of the entrance guard controllers is connected to a controlling device of an electric lock and a display unit.

10. The system of claim 5, wherein each of the entrance guard controllers is connected to a controlling device of an electric lock and a display unit.
